(19) United States
(12) Patent Application Publication
(10) Pub. No.: US 2026/0288543 A1
(43) Pub. Date: Sep. 24, 2026

(54) MACHINE-LEARNING FREQUENCY AND POWER PREDICTIONS FOR INTEGRATED HARDWARE CIRCUITS

(71) Applicant: Google LLC, Mountain View, CA (US)

(72) Inventors: Lijun Li, San Diego, CA (US); Xiaoping Xie, Cupertino, CA (US)

(21) Appl. No.: 19/476,535

(22) PCT Filed: Feb. 27, 2024
(86) PCT No.: PCT/US2024/017525

§ 371 Date: Oct. 17, 2025

(30) Foreign Application Priority Data
Apr. 20, 2023 (WO) PCT/US2023/019281

(51) Int. Cl. G06F 9/50; G06F 15/78

(52) U.S. Cl. CPC G06F 9/5094; G06F 15/7807

(57) ABSTRACT

Methods and systems, including computer-readable media, are described for implementing frequency and power predictions for an integrated circuit of a System-on-Chip (“SoC”). The system detects that an application is being executed at the SoC and determines a workload type of the application based on an indicator generated concurrent with the application being executed. Inferences are computed by a DVFS prediction engine of the SoC based on the workload type and the indicator. The inferences are used to achieve a threshold quality of service (“QoS”) when the application is executed at the SoC. The DVFS prediction engine generates a predicted frequency value and a predicted power value from the computed inferences. The predicted frequency value or power value is used to adjust an operating frequency or a power output at the hardware integrated circuit to achieve a threshold QoS when the application is executed at the SoC.

### BACKGROUND

This specification generally relates to machine-learning and integrated circuits.

Machine-learning models can employ neural networks with one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing.

Different types of machine-learning architectures can be used to perform a variety of tasks related to classification or pattern recognition, predictions that involve data modeling, and information clustering. A neural network layer can have a corresponding set of parameters or weights. The weights are used to process inputs (e.g., a batch of inputs) through the neural network layer to generate a corresponding output of the layer for computing a neural network inference. A batch of inputs and a set of kernels can be represented as respective tensors, i.e., a first multi-dimensional array of inputs and a second, different multi-dimensional array of weights.

A hardware accelerator is a special-purpose integrated circuit for implementing neural networks or other machine-learning models. The integrated circuit can include memory used to store data for multiple tensors. The memory includes individual memory locations that are identified by unique addresses (e.g., virtual or physical addresses). The address locations can correspond to elements of a tensor. Data corresponding to elements of one or more tensors may be traversed or accessed using control logic of the integrated circuit.

### SUMMARY

This specification describes machine-learning (ML) techniques and corresponding predictive models configured to generate frequency and/or power predictions for operating individual components and processor devices of a System-on-Chip (“SoC”). The predictive ML model(s) generates a frequency or power prediction based on a detected workload type of an application and associated indicators that are processed when the application is executed using the SoC. The frequency and power predictions establish dynamic voltage and frequency scaling (“DVFS”) values that are applied to the components of the SoC to improve or enhance overall performance at the SoC.

A DVFS prediction engine of the SoC includes, or communicates with, a workload detector and predictive ML models that leverage adaptive learning to execute a comprehensive DVFS framework for regulating DVFS settings at the SoC. The workload detector generates a workload type for an application executed at a user device. The workload type (e.g., gaming) is passed to the predictive ML models of the DVFS framework to compute inferences that are used to achieve a threshold quality of service (“QoS”) when the application is executed at the SoC. The DVFS prediction engine generates a predicted frequency value and a predicted power value from the computed inferences.

The DVFS prediction engine uses the predicted values to more efficiently adjust DVFS settings, for example, to achieve the fastest frequency and lowest power consumption operating points. For example, progressing through scene changes in a first-person gaming application executed at a user device may require executing a graphics intensive workload at the SoC. The DVFS prediction engine can be used to determine operating points at the SoC that maximize frequency and duty cycle, while also optimizing QoS and minimizing power consumption. The DVFS settings can be used to achieve a threshold level of performance while also minimizing the resource overhead required to achieve that performance level.

One aspect of the subject matter described in this specification can be embodied in a computer-implemented method for frequency and power predictions at a hardware integrated circuit. The method includes detecting that an application is being executed at an SoC of the hardware integrated circuit and determining a workload type of the application based on an indicator generated concurrent with the application being executed. The method includes computing ML inferences by a DVFS prediction engine of the SoC based on the workload type and the indicator. The ML inferences are used to achieve a threshold QoS when the application is executed at the SoC. The DVFS prediction engine generates a predicted frequency value and a predicted power value from the computed inferences. The method further includes adjusting, using the predicted frequency value or power value, an operating frequency or a power output at the hardware integrated circuit to achieve a threshold QoS when the application is executed at the SoC.

These and other implementations can each optionally include one or more of the following features. For example, in some implementations, generating a predicted frequency value and a predicted power value from the computed inferences includes generating, by the DVFS prediction engine, a minimum frequency value and a corresponding minimum power value to achieve the threshold QoS when the application is executed at the SoC. In some implementations, generating a predicted frequency value and a predicted power value from the computed inferences includes generating, by the DVFS prediction engine, a maximum frequency value and a corresponding minimum power value required to implement a maximum operating frequency at the hardware integrated circuit based on the maximum frequency value.

Computing the inferences can include computing inferences by a frequency prediction model of the DVFS prediction engine based on the workload type and the indicator; and computing inferences by a power prediction model of the DVFS prediction engine based on the workload type and the indicator. In some implementations, the SoC is integrated in a user device; and the frequency prediction model is trained and executed on the SoC. The power prediction model can be a pre-trained neural network model and the power prediction model can be trained offline, separate from the SoC and the user device, and then loaded onto the SoC for execution at the user device.

In some implementations, the SoC is for a user device and the method further includes: i) determining a first workload type of a first application executed at the user device; ii) adjusting the operating frequency and the power output at the hardware integrated circuit using predicted frequency and power values generated from inferences computed by the DVFS prediction engine based on the first workload type; iii) determining a second workload type of a second application executed at the user device; and iv) adjusting the operating frequency and the power output at the hardware integrated circuit using predicted frequency and power values generated from inferences computed by the DVFS prediction engine based on the second workload type.

The method further includes adjusting the operating frequency or the power output with reference to the first workload type to achieve a first threshold QoS when the first application is executed at the SoC; and adjusting the operating frequency or the power output with reference to the second workload type to achieve a second threshold QoS when the second application is executed at the SoC. In some implementations, the first workload type and the second workload type are different workload types; and the first application and the second application are the same application. In some implementations, computing the inferences includes computing the inferences based on the workload type, multiple software indicators, and multiple hardware indicators.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages.

The disclosed techniques can provide granular controls for frequency and power outputs to efficiently regulate DVFS settings at an SoC of a user device such as a tablet or smartphone. The frequency and/or power prediction models of a DVFS prediction engine can predict, infer, or otherwise determine a respective frequency and power output value when an application is launched at a user device. Relatedly, the DVFS prediction engine can infer, predict, or otherwise determine QoS requirements such as frames-per-second (FPS), latency, and system-level power constraint based on inferences computed by the frequency prediction model, the power prediction model, or both.

The DVFS prediction engine can execute a comprehensive DVFS framework that leverages adaptive learning to regulate DVFS settings at the SoC. The predicted frequency and power values are passed to the DVFS framework and used to more efficiently adjust DVFS settings, for example, to achieve operating points that allow for the fast and power efficient performance. For example, when executing an application, the frequency and power prediction models are used to determine operating points at the SoC that optimize quality of service while minimizing power consumption. Thus, the DVFS settings are used to maximize performance of integrated circuits on the SoC while also minimizing the resource overhead required to achieve that maximum performance.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system of a System-on-Chip.

FIG. 2 shows an example workload type detection algorithm.

FIG. 3 shows an example flow diagram for determining a Quality-of-Service deviation for a particular workload type.

FIG. 4 shows an example adaptive ML training/self-learning module.

FIG. 5 is an example process for workload detection using the computing system of FIG. 1.

FIG. 6 shows an example frequency prediction model.

FIG. 7 shows an example power prediction model.

FIG. 8 is an example process flow diagram for training frequency and power prediction models.

FIG. 9 is an example process for frequency and power predictions at a hardware integrated circuit.

Like reference numbers and designations in the various drawings indicate like elements.

### DETAILED DESCRIPTION

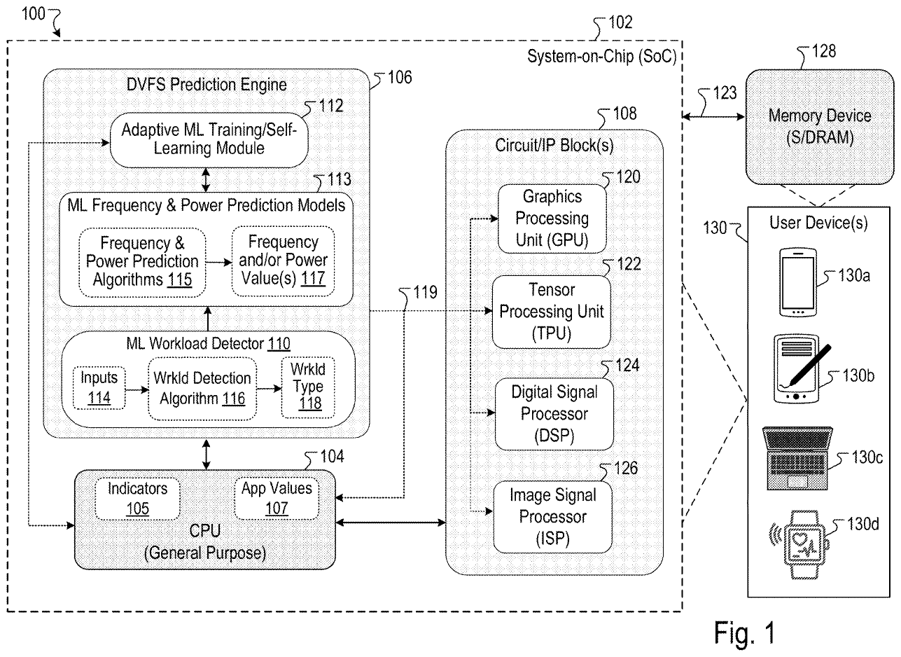

FIG. 1 is a block diagram of an example computing system 100 that includes a system-on-chip 102 (“SoC 102”). The SoC 102 includes a central processing unit 104 (“CPU 104”), a dynamic voltage and frequency scaling (“DVFS”) prediction engine 106, and a circuit block 108. The CPU 104 generates one or more indicators 105, such as an app-launch indicator or a function call that is triggered in response to executing or launching an application at a user device. The CPU 104 also generates one or more application values 107. The application values 107 may be associated with a function call, may be descriptive of an event that occurs during execution of the application, or both.

The CPU 104 can be a general-purpose CPU (e.g., a single or multi-core CPU). In some implementations, the DVFS prediction engine 106 is implemented as a software module of the CPU 104 that uses one or more hardware resources of the CPU 104. In some examples, the CPU 104 is configured as an instruction and vector data processing engine that processes data obtained from a system memory of the SoC 102. At least one processor of the circuit block 108 can also include, or be configured as, an instruction and vector data engine that operates on vectors and matrices of data and/or operands.

The DVFS prediction engine 106 includes, or is configured to access, a workload detector 110, an adaptive ML training/self-learning module 112 (“adaptive learning module 112”), and DVFS prediction models 113. The DVFS prediction engine 106 can be implemented in software, hardware, or both. Aspects of the DVFS prediction engine 106 can be also implemented as firmware of the SoC 102 or a device of the SoC 102, such as the CPU 104 or a device of the circuit block 108. As described in detail below, the DVFS prediction engine 106 is configured to generate control signaling used to dynamically regulate voltage (or current) and frequency settings (“DFVS settings”) across components system 100.

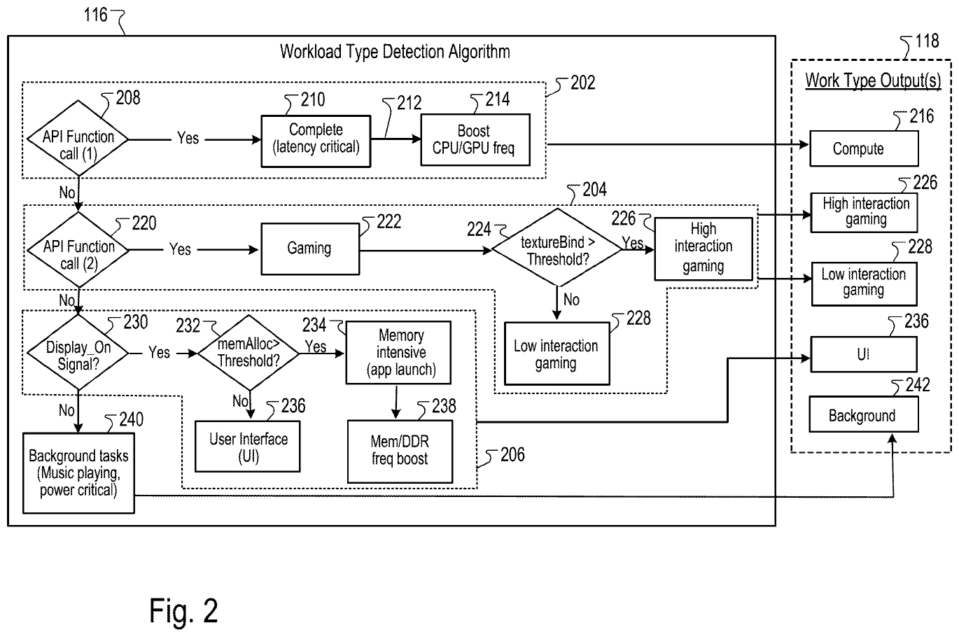

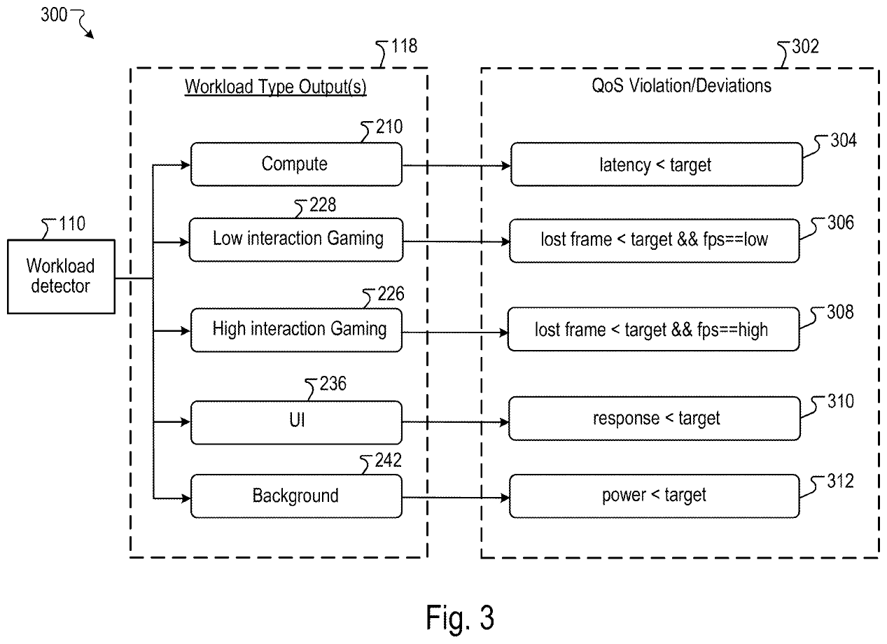

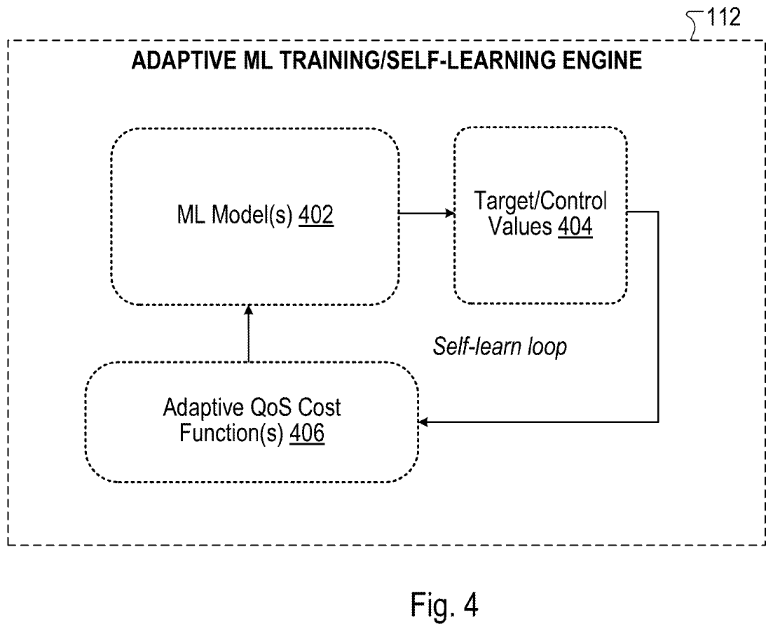

The workload detector 110 receives inputs 114, which correspond to indicators 105 and application values 107. The workload detector 110 processes the inputs 114 using an example workload detection algorithm 116 to generate one or more workload types 118. This is described below with reference to FIG. 2. The adaptive learning module 112 uses an adaptive cost function to iteratively adjust QoS parameters of the DVFS prediction engine 106. This is described below with reference to FIG. 3 and FIG. 4.

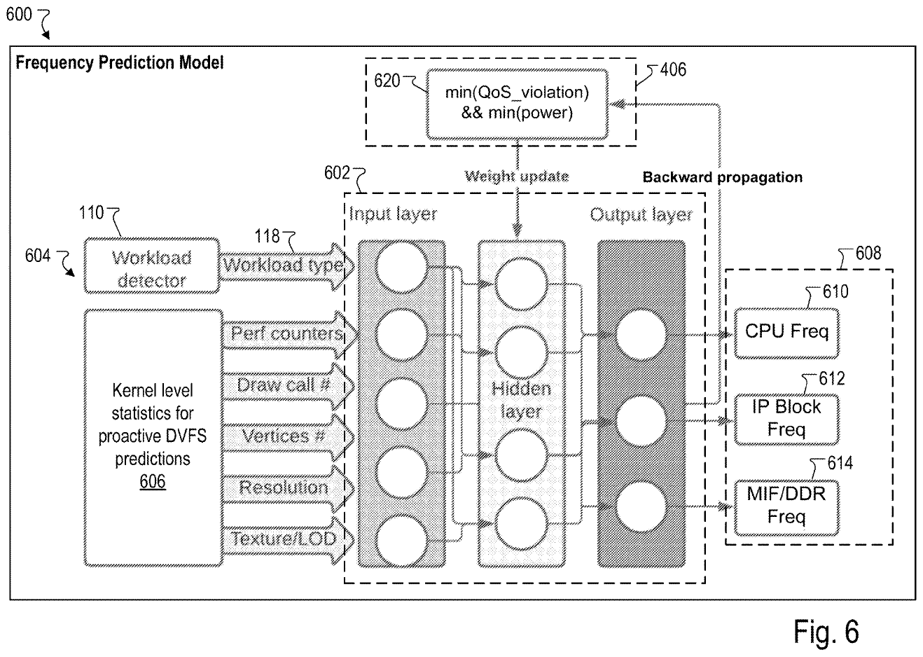

The DVFS prediction models 113 communicates with the CPU 104 and the workload detector 110, and includes predictive ML models that leverage adaptive learning algorithms 115 to execute a comprehensive DVFS framework for regulating DVFS settings at the SoC 102. For example, the DVFS prediction models 113 includes a frequency prediction ML model that predicts and/or generates frequency values and a power prediction ML model that predicts and/or generates power values/settings. In some implementations, the predicted frequency and power values define one or more DVFS settings at the SoC 102. The frequency and power prediction ML models of the DVFS prediction models 113 are described in more detail below with reference to FIG. 6-FIG. 8.

The workload detector 110 generates a workload type 118 for an application executed at a user device. The workload type (e.g., gaming) and related inputs 114 are passed to the predictive ML models of the DVFS framework as inputs for computing inferences and corresponding outputs. The computations and corresponding outputs are used to achieve a threshold quality of service (“QoS”) when the application is executed at the SoC 102. For example, the DVFS prediction models 113 generates predicted frequency values and predicted power values as outputs from the computed inferences. The DVFS prediction models 113 uses the predicted values to efficiently adjust DVFS settings, for example, to achieve the lowest, fastest operating points for various IP devices of the SoC 102.

The circuit block 108 can be an Intellectual Property (IP) circuit block with one or more IP devices. Thus, the circuit block 108 is referred to alternatively as an IP block 108, where the IP block(s) can include one or more proprietary IP hardware devices/components. For example, the IP/circuit block 108 can include a graphics-processing unit (GPU) 120, a tensor processing unit (TPU) 122, a digital signal processor (DSP) 124, and an image signal processor (126). In some implementations, a memory device 128 is also included among the devices of the IP circuit block 108. In some implementations, each of the GPU 120, TPU 122, DSP 124, ISP 126, and memory device 128 can be a proprietary IP block of a particular entity or device manufacturer.

In the example of FIG. 1 memory device 128 is depicted as being separate from the SoC 102 and IP block 108. However, aspects of memory device 128 can be: i) local to IP block 108 and the SoC 102, ii) external to IP block 108 and the SoC 102, or iii) both. In some implementations, the memory device 128 is an example random access memory of the SoC 102, such as a dynamic random-access memory (DRAM), a synchronous DRAM (SDRAM), or double data rate (DDR) SDRAM. In some other implementations, memory device 128 can be or include various other types of memory, such as high bandwidth memory (HBM), a narrow memory (e.g., for storing 8-bit values), wide memory (e.g., for storing 16-bit or 32-bit values), etc.

In the example of FIG. 1, system 100 and the SoC 102 is an integrated circuit of an example user/client device, consumer electronic device, or mobile device, where each of these devices can include items such as a smartphone 130a, tablet 130b, laptop 130c, smartwatch or wearable device 130d. The devices may also include other items such as an eNotebook, Netbook, smart speaker, or mobile computer. In some implementations, the system 100, including the SoC 102, is an integrated circuit of a desktop computer, network server, or related cloud-based asset.

The DVFS prediction engine 106 uses operations performed by the workload detector 110, adaptive learning module 112, and DVFS prediction models 113 to dynamically control DVFS settings across the SoC 102, including the CPU 104 and devices of the IP blocks 108. More specifically, the DVFS prediction engine 106 is configured to generate control signaling 119 and use one or more discrete control values of the control signaling 119 to regulate at least the voltage, current, and frequency values for DFVS settings of at least the IP blocks 108, the CPU 104, the memory device 128, or a combination of these.

For example, the control signaling 119 can include: i) at least one control value for regulating DVFS settings at the CPU 104, ii) at least one control value for regulating DVFS settings at the GPU 120, iii) at least one control value for regulating DVFS settings at the TPU 122, iv) at least one control value for regulating DVFS settings at the DSP 124, and v) at least one control value for regulating DVFS settings at the ISP 126. Relatedly, the control signaling 123 can include at least one control value for regulating DVFS settings at the memory device 128. In some implementations, each processor (e.g., a CPU, GPU, or TPU) of the SoC 102 includes multiple cores and the DVFS prediction engine 106 can generate control signaling 119 to regulate or adjust DVFS settings at each core of the processor.

FIG. 2 shows an example workload type detection algorithm 116 (“algorithm 116”) executed by the workload detector 110. The workload detector 110 can detect or determine workload types based on a static algorithm, a machine-learning (“ML”) algorithm, or both. Whether static or ML-based, the workload detector 110 leverages a unique detection algorithm 116 to generate an output specifying a detected workload type 118.

In some implementations, algorithm 116 represents a process, procedure, or set of rules for performing computations or other problem-solving operations executed by the DVFS prediction engine 106, the workload detector 110, or both. As indicated below, the process, procedure, or set of rules may correspond to one or more compute flows. To the extent algorithm 116 is described as performing an action, e.g., detecting, determining, executing, or generating, such actions are performed based on execution of algorithm 116 by the DVFS prediction engine 106, the workload detector 110, or other devices of system 100.

As described above, the workload detector 110 processes the inputs 114 in accordance with the algorithm 116 to generate one or more workload types 118. In general, the workload detector 110 initiates its operations to detect a workload type in response to detecting or determining that an application has been launched or executed at user device 130. The detectable workload types include a compute workload type, a high-interaction gaming workload type, a low-interaction gaming workload type, a user-interface workload type, and a background workload type. Other workload types, such as memory intensive workloads, streaming workloads, or GenAI workloads, are also within the scope of this disclosure.

The types of workloads detected by the workload detector 110 can be workloads that are processed by system 100 to generate an application output, such as graphical content rendered at a display of the user device 130. For example, the application can be a gaming application, such as a first-person shooter game or a first-person racing/driver game. In this example, gaming sequences of the application are rendered at a display of user device 130 using one or more resources of the IP blocks 108.

The algorithm 116 can include one or more compute flows 202, 204, 206 for at least a subset of the workload types that are detectable by the workload detector 110. At compute flow 202 the algorithm 116 determines whether a first API function call is detected or triggered (208). The first API function call can be one or more software indicators (or software hints) that indicate a particular workload is compute intensive, has sensitivities to high/long latency, and/or is required to be executed with low latency or within a threshold time duration. The first API function call can include one or more of an OpenCL API call, an OpenGL API call, or a Vulkan API call.

In general, OpenCL is an API call that can be issued at the SoC 102 to execute computations using one or more computational resources of system 100, such as the TPU 122, whereas OpenGL and Vulkan are respective API calls that can be issued at the SoC 102 to execute certain graphical operations using one or more graphics processing resources of system 100, such as the GPU 120. For example, the OpenGL is applied at the SoC 102 to generate user interface (UI) animations, manage embedded video functions, or build vector graphics for rending visual elements of a given application.

The API function calls can be managed by the CPU 104. In some implementations, each API function call is, or corresponds to, a software indicator that is generated by the CPU 104, detected by the CPU 104, or both. Thus, algorithm 116 can make determinations about the first API function call based on one or more indicators 105 detected by the CPU 104. If algorithm 116 determines that a first API function call was detected or triggered, then algorithm 116 determines that the workload is a compute heavy workload (210). If algorithm 116 determines that a first API function call was not triggered, then the algorithm 116 transitions to compute flow 204.

In response to determining that the workload is a compute heavy workload, the algorithm 116 causes the DVFS prediction engine 106 or the CPU 104 to generate a control signal 212. More specifically, the algorithm 116 (or workload detector 110) can determine that a workload of the application is a compute workload 216 based on a determination that the first API function call was detected, in response to generating control signal 212, or both.

The control signal 212 is used to boost one or more operating frequencies (214) of at least the CPU 104, the GPU 120, or both. In some implementations, the control signal 212 is used to boost a respective operating frequency of other resources of the SoC 102. For example, the control signal 212 can be passed to the CPU 104 and/or the GPU 120 to boost a respective operating frequency of those devices in accordance with frequency predictions and power predictions generated by DVFS prediction models 113. In some implementations, the control signal 212 is passed to individual frequency and power prediction models to generate respective minimum frequency values and power setting values to implement the corresponding boost in operating frequency.

In some implementations, using the algorithm 116, the DVFS prediction engine 106 determines that the compute heavy workload is latency critical or involves one or more operations that are latency critical. In this implementation, the control signal 212 corresponds to a DVFS control signal that is passed to a resource of the SoC 102 (e.g., the GPU 120) to boost a particular DVFS setting (e.g., frequency) of that resource. The DVFS prediction engine 106 boosts the particular DVFS setting to ensure the latency-critical, compute-heavy workload can meet or exceed the required latency (e.g., low-latency) when the workload is executed by the SoC 102.

At compute flow 204 the algorithm 116 determines whether a second API function call is detected or triggered (220). The second API function call can be one or more software indicators (or software hints) that indicate a particular workload is graphics intensive, has sensitivities to lost frames or frame rate, and/or is required to render graphical content with sufficient detail, resolution, or both. The second API function call can include at least a textureBind API call or other related API calls that are used to render graphical content, including textures and other details of that graphical content. In some implementations, the second API function call(s) can include one or more of the API function calls that were described above with reference to the first API function call.

In general, textureBind is an API call that can also be issued at the SoC 102 to execute certain graphical operations using one or more graphics processing resources of system 100, such as the GPU 120. More specifically, textureBind can refer to, or indicate movement of, a scene or avatar that triggers texture changes in graphical content generated for an application. The texture changes are signaled by a textureBind call and one or more values of the textureBind call are used to determine and/or generate a high-interaction parameter signal to indicate a high-interaction gaming mode.

In some implementations, the high-interaction parameter signal is used or processed at the workload detector 110 to indicate that one or more gaming scenes or gaming content has a high FPS requirement or at least an FPS that is required to be above a particular threshold. Examples of a high FPS requirement can vary depending on the type of user device 130 (e.g., smartphone or laptop) as well as other factors such as a screen refresh rate of the user device 130 or a resolution of the device's display. A maximum FPS of a user device 130 can be limited by a screen refresh rate of a display screen of the device. For example, if user device 130 is a mobile/smart phone, then a typical refresh rate of its screen can range from 240 Hz or 120 Hz. So, in this example, the maximum FPS will be up to 120 or 240. In some cases, a high FPS is determined relative to a given resolution, such as 1280×800 or 1280×32.

The workload detector 110 uses algorithm 116 to execute a comparative operation that assesses an example incoming textureBind value against a threshold value. In some implementations, the threshold value is adaptive or dynamically determined at system 100. Example textureBind threshold values can vary (e.g., 1000 or 1200) depending on the gaming application or workload. The comparative operation is executed to determine if an application, or a workload associated with the application, is a high-interaction gaming workload or low-interaction gaming. The second API function calls can be also managed by the CPU 104. In some implementations, the second API function call is, or corresponds to, a software indicator that is generated by the CPU 104, detected by the CPU 104, or both. Thus, algorithm 116 can make determinations about the second, different API function call based on one or more indicators 105 detected by the CPU 104.

If algorithm 116 determines that a second API function call was detected or triggered, then algorithm 116 determines that the workload is a gaming workload (222). If the algorithm 116 determines that a textureBind API call was not triggered, then the algorithm 116 transitions to compute flow 206.

In response to determining that the workload is a gaming workload, the algorithm 116 determines whether a textureBind value exceeds a threshold value. This determination is described above with reference to the comparative operation involving the incoming textureBind value and the textureBind threshold. If algorithm 116 determines that a textureBind value exceeds a threshold value, then algorithm 116 detects or determines that the workload is a high-interaction gaming workload 226. However, if the algorithm 116 determines that a textureBind value does not exceed the threshold value, then the algorithm 116 detects or determines that the workload is a low-interaction gaming workload 228.

When the workload detector 110 determines that the workload is a high-interaction gaming workload 226, the algorithm 116 causes the DVFS prediction engine 106 or the CPU 104 to generate a control signal that boosts one or more operating frequencies of at least the GPU 120. This control signal can be also used to boost a respective operating frequency of other resources of the SoC 102. In some instances, this control signal corresponds to the high-interaction parameter signal described above.

In some implementations, using the algorithm 116, the DVFS prediction engine 106 determines that the high-interaction gaming workload 226 is a frame-critical workload, a frame-rate critical workload, or involves one or more operations that are particularly sensitive to missed, dropped, or lost frames. In this implementation, the high-interaction parameter signal corresponds to a DVFS control signal that is passed to a resource of the SoC 102 (e.g., the GPU 120) to boost a particular DVFS setting (e.g., frequency) of that resource. The DVFS prediction engine 106 boosts the particular DVFS setting to ensure the frame-critical, high-interaction workload can meet or exceed the target requirement for lost frames when the workload is executed at the SoC 102.

At compute flow 206 the algorithm 116 determines whether a display_on signal is detected or triggered (230). In some implementations, the display_on signal is, or corresponds to, a software/hardware indicator that is generated by the CPU 104, detected by the CPU 104, or both. Thus, algorithm 116 can make determinations about the display_on signal based on one or more indicators 105 detected by the CPU 104. For example, the display_on signal can be a software indicator (or software hint) that indicates a device state of a user device 130, such as whether a screen or display of the user device is on or off.

If the workload detector 110 determines that a display_on signal was detected or triggered, then the algorithm 116 determines whether a detected memory allocation is greater than a threshold memory allocation (232). If algorithm 116 determines that a display_on signal was not detected or triggered, then algorithm 116 causes the workload detector 110 to generate an output specifying a detected workload type is a background workload. This is described in more detail below.

If the detected memory allocation exceeds a threshold memory allocation, then the workload detector 110 determines that a workload associated with an application is memory intensive (234) user interface (UI) workload. If the detected memory allocation does not exceed a threshold memory allocation, then the workload detector 110 (or the algorithm 116) determines that a workload associated with an application is a non-memory intensive UI workload (236), such as a workload to generate UI elements that is not particularly memory intensive.

In some implementations, to determine that a workload is memory intensive, the workload detector 110 receives a memory allocation input (e.g., mem_alloc) and analyzes or otherwise uses that memory allocation input to determine whether the workload is a memory intensive or non-memory intensive workload. The memory allocation input may be among the hardware/software indicators 105 detected (or generated) by the CPU 104. In some implementations, the memory allocation information is provided by, or obtained from, an operating system (OS) kernel.

If or when the workload detector 110 determines that a workload or application is memory intensive (234), then the workload detector 110 (or algorithm 116) causes the DVFS prediction engine 106 or the CPU 104 to generate a control signal that boosts one or more operating frequencies (238) of at least the memory device 128. This control signal can be also used to boost a respective operating frequency of other resources of the SoC 102. For example, this control signal can be used to boost frequencies for a memory interface to expedite obtaining certain data, such as data produced by the CPU 104 for specific gaming application drivers.

In some implementations, a control signal that boosts an operating frequency of memory device 128 represents a RAM/DDR frequency boost signal and the DVFS prediction engine 106 (or the CPU 104) can generate multiple memory frequency boost signals. The memory device 128 can include multiple DDR/DRAM modules and each RAM/DDR boost signal can be used to boost a respective operating frequency of a corresponding DDR/DRAM module. For example, an operating frequency of the memory device 128 can be boosted from 900 MHz to 1.2 GHz.

For context, a particular application, such as a gaming app, that is launched at user device 130 can have processing and graphics resource requirements that sometimes cause a bottleneck on the CPU 102. For example, the CPU 102 may manage executing or running drivers for a gaming application, such that the CPU 102 is both a consumer and producer of data required to execute the application (or a workload) at user device 130. When the CPU 104 is a producer of data it may be required to forward data for initial or further processing via a resource of the IP block 108, such as the GPU 120.

If a particular workload or application is determined to be memory intensive, then the CPU 104 can be required to produce and feed data corresponding to multiple memory allocations (e.g., a large amount of data) to a specific resource of the IP block 108. In some implementations, for certain graphical user interface (GUI) operations that require a fast CPU response time, the CPU 104 is required to produce and feed a large amount of data rapidly to the GPU 120 or TPU 122.

In this implementation, the CPU 104 can become a bottleneck for the compute flow if the CPU 104 feeds the information to the GPU too slowly. This is especially true for workloads or applications that are memory intensive. So, as described above, using algorithm 116, the workload detector 110 causes the DVFS prediction engine 106 to generate a control signal that boosts or otherwise adjusts one or more operating frequencies (238) of memory modules at the memory device 128. The frequency can be increased to expedite obtaining and forwarding data required to execute memory intensive workloads of an application.

In general, launching an application at user device 130 triggers or requires an allocation of memory resources, such as buffers, registers, cache, main memory, etc. For example, in response to detecting an app_lauch signal, the CPU 104 can use an allocation signal (e.g., alloc page) to process an application's request for memory. In some implementations, the memory allocation required to execute an application workload is proportional to a number of API function calls. The workload detector 110 can determine a weighting between at least a relative size of the requested memory allocation and number of API function calls, and determine a workload type based on the determined weighting.

As noted above, if the algorithm 116 determines that a display_on signal was not detected or triggered, then the algorithm 116 transitions from compute flow 206 to a background compute flow 240 and causes the workload detector 110 to generate an output specifying a detected workload type is a background workload 242. In some implementations, the background workload 242 involves one or more background tasks. The background workload 242 can be an example non-GUI workload that involves a display_off device state.

For example, during execution of the application, its underlying background workload 242 involves tasks where a display or screen of user device 130 can be turned-off without impacting execution of the application, the workload, or discrete tasks of the workload. In some implementations, the application itself, or a task of the background workload 242, is for receiving text messages, tracking alarm conditions of an alarm clock, or some other action that requires power but requires a minimal processing and memory resources.

Based on algorithm 116, the workload detector 110 can detect or determine that an application or background workload 242 is a power-critical app (or workload). For example, the workload detector 110 can detect or determine a device state indicator corresponding to a power state of a display of the user device 130. In some implementations, a bit value of the device state indicator indicates whether the application is a power-critical application. Using this detection, the DVFS prediction engine 106 can determine that establishing or preserving a low-power state is a main priority of the SoC 102.

The device state indicator is used to generate a DVFS control value with reference to a background task of the application or workload. More specifically, the DVFS control signaling 119 can include a DVFS control value generated based on the bit value of the device state indicator and with reference to a background task of the application. For example, the DVFS prediction engine 106 can generate a DVFS control signal 119 that is passed to resources of the SoC 102 (e.g., the IP block 108) to establish low-power DVFS settings (e.g., voltage, current, frequency, etc.), for example, by reducing operating voltages and frequencies across the SoC 102.

FIG. 3 shows an example flow diagram for a deviation module 300 used to determine a QoS violation (or deviation) for a particular workload type. As described above, the workload detector 110 is configured to detect multiple types of workloads 118. For a given application, the workload detector 110 can detect or determine at least a compute workload 210, a high-interaction gaming workload 226, a low-interaction gaming workload 228, a UI/GUI workload 234, and a background workload 242.

The deviation module 300 includes comparator logic 302, which comprises multiple comparators. More specifically, the comparator logic 302 includes a latency comparator 304, a first frame comparator 306, a second frame comparator 308, a UI response comparator 310, and a power comparator 312. The latency comparator 304 compares a detected or observed latency to a target latency and generates a QoS violation if the observed latency is less than the target. An example target latency can be 200 milliseconds (ms) or 300 ms.

The first frame comparator 306 compares: i) a detected or observed lost frame value to a target lost frame value and ii) a detected or observed FPS to a target FPS (e.g., low). The first frame comparator 306 generates a QoS violation if the observed lost frame value is less than the target value and if the observed FPS is not equal to the target FPS. Similarly, the second frame comparator 308 compares: i) a detected or observed lost frame value to a target lost frame value and ii) a detected or observed FPS to a target FPS (e.g., high). The second frame comparator 308 generates a QoS violation if the observed frame loss value is less than the target and if the observed FPS is not equal to the target FPS.

The UI response comparator 310 compares a detected or observed UI response to a target response and generates a QoS violation if the observed UI response is less than the target. The power comparator 312 compares a detected or observed power value to a target power and generates a QoS violation if the observed power values are less than the target.

FIG. 4 shows an example adaptive ML training/self-learning module 112. The adaptive learning module 112 includes one or more machine-learning models 402, a set of control values 404, and one or more adaptive QoS cost functions 406.

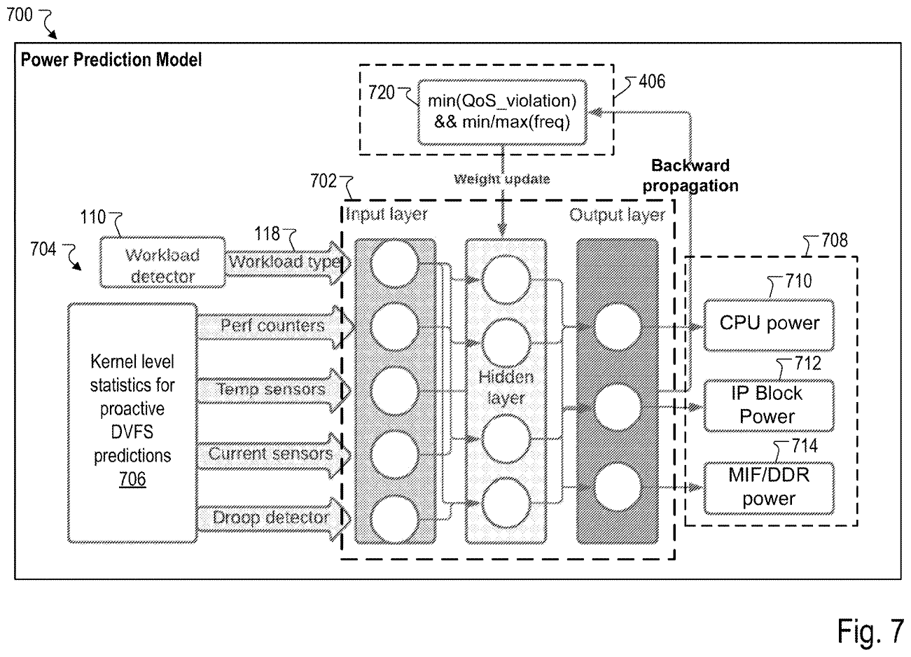

The QoS cost function(s) 406 is used to measure, evaluate, or otherwise determine the performance of ML models for a given data set. At least one of the machine-learning models 402 can be implemented using an artificial neural network with multiple layers, including one or more hidden layers. In some implementations, the QoS cost function(s) 406 quantifies an error between predicted and expected values. The predicted and expected values can be represented by inference outputs of the ML models 402, such as frequency prediction ML models and power prediction ML models described below with reference to the examples of FIG. 6 and FIG. 7, respectively.

For example, DVFS prediction engine 106 is configured to compute inference outputs using the workload detector 110, the adaptive learning module 112, or both. The inference outputs can include a detected workload type (e.g., high interaction gaming workload) and multiple quality control values 404, such as a target value for frames-per-second (fps), a target frequency value, or a target power value. To compute the inference outputs, the DVFS prediction engine 106 can process ML inputs corresponding to each function call indicator through a hidden layer (e.g., a neural network layer) of at least one ML model 402. For example, the ML inputs can be processed through the hidden layer in accordance with the adaptive ML algorithm.

The quality control values can be computed by applying an adaptive ML algorithm to some (or all) of the hardware & software indicators 105, the application values 107, or both. The quality control values 404 can be threshold values for enforcing certain quality of service requirements, such as ensuring an image post-processing operation is computed as fast as possible (e.g., minimal latency) or that a gaming application iterates through multiple scene changes without dropping a single frame.

The adaptive learning module 112 can use an adaptive QoS cost function 406 to generate an output (e.g., a real number) representing the quantified error. The adaptive learning module 112 can also use the QoS cost function 406 to iteratively adjust control values for QoS parameters of the DVFS prediction engine 106. The control values include target values and a corresponding threshold value for each target value. In one or more examples, a target value and a threshold value can be the same value. The QoS parameters correspond to the one or more detectable workload types and include parameters such as latency, power, lost/missed frames, frame rate, and UI response time. Other parameters relating to application performance and determining DVFS settings are also within the scope of this disclosure.

The adaptive learning module 112 uses the QoS cost function 406 to compute a respective deviation value for a QoS parameter. For example, a respective deviation value can be computed based on a particular quality control value 404 that corresponds to the QoS parameter and at least one of: i) one or more function call indicators and ii) one or more application values 107. The self-learn loop of the adaptive learning module 112 is leveraged to compute inference outputs that include one or more control values 404 that were previously updated based on: i) the adaptive cost function 406 and ii) at least one of the respective deviation values for particular QoS parameters.

The adaptive learning module 112 can include multiple QoS cost functions 406, where each QoS cost function 406 may correspond to one or more ML models 402. For example, the adaptive learning module 112 can include an ML model 402 and an adaptive QoS cost function 406 for each workload type that is detectable by the workload detector 110. The adaptive learning module 112 is configured to dynamically determine control values, including thresholds, for each QoS parameter based on the one or more ML models and corresponding QoS cost function 406. In some implementations, the DVFS prediction engine 106 is configured as an integrated workload detection, frequency prediction, and power prediction ML model that generates multiple DVFS control values based on one or more inference outputs.

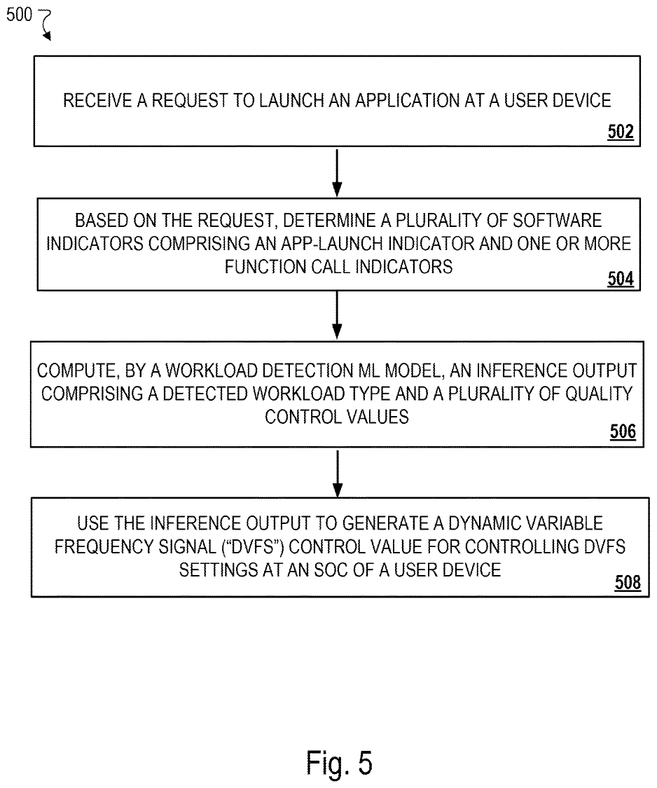

FIG. 5 is an example process 500 for workload detection and adjusting DVFS settings using the computing system of FIG. 1. One or more steps of process 500 are performed to determine one or more attributes of an application workload using a workload detector of a DVFS prediction engine. More specifically, the workload detection and adjusting of the DVFS settings are performed based on a workload detection machine-learning (“ML”) model that is implemented at the workload detector 110, the DVFS prediction engine 106, or both.

In general, process 500 can be implemented or executed using system 100 and the SoC 102 described above. Hence, descriptions of process 500 may reference the above-mentioned computing resources of system 100 and SoC 102. In some examples, the steps or actions of process 500 are enabled by programmed software instructions, firmware instructions, or both. Each type of instruction may be stored in a non-transitory machine-readable storage device and is executable by one or more of the processors or other resources described in this document, such as the CPU 104, a scalar core or compute tile of the TPU 122, a hardware ML accelerator, or a neural network processor.

In some implementations, the steps of process 500 are performed at a hardware integrated circuit to generate a machine-learning (ML) output, including an output for a neural network layer of a neural network that implements one or more ML models. For example, the output can be a portion of a computation for a ML task or inference workload to generate an image processing, speech processing, or image recognition output. As indicated above, the integrated circuit can be a special-purpose neural network processor or hardware ML accelerator configured to accelerate computations for generating different types of data processing outputs.

Referring again to process 500, the system 100 receives a request to launch an application at a user device (502). More specifically, an SoC 102 of a user device such as user 130a/b/c receives a request to launch an application at the user device 130. For example, the user device 130 can receive an input request from a user to launch a gaming application, such as Halo® or Call of Duty®. The system 100 identifies, detects, or otherwise determines one or more software (and/or hardware) indicators 105 based on the request (504). The multiple software (and/or hardware) indicators 105 can form a set of inputs 114 that include an app-launch indicator and one or more function call indicators. As the name implies, the app-launch indicator indicates that an application has been launched at the user device 130.

The workload detection ML model computes an inference output comprising a detected workload type and multiple quality control values (506). For example, the workload detection ML model computes the inference output by applying an adaptive ML algorithm of the workload detection ML model to each of the indicators 105. In some implementations, the workload detection ML model uses one or more of compute flows 202, 204, 206 to compute or generate the inference output. For example, an output of the compute flow 202 can be an indication that an application workload is a compute workload 216. The workload detector 110 uses this indication to generate and output a workload_type signal that specifies the detected type of the workload.

The system 100 uses the inference output to generate a Dynamic Variable Frequency Signal (“DVFS”) control value (508). In some implementations, the workload detector 110 passes a detected workload type 118 as an output signal to the adaptive ML training/self-learning module 112. For example, the workload detector 110 can pass the detected workload type 118 along with one or more application values 107 or cause the CPU 104 to pass the one or more application values 107. The DVFS prediction engine 106 uses the inference output to generate a DVFS control value.

The DVFS control value is for controlling DVFS settings at the SoC 102 based at least on the detected workload type 118. For example, the workload detector 110 can determine that a workload associated with an application is a high-interaction gaming workload and system 100 can use the DVFS control value to control DVFS settings of the GPU 120 to minimize or eliminate frame loss at the user device 130 as the application transitions through different scenarios of the high-interaction game. In some implementations, the DVFS settings are controlled in a manner that allows users to play high interaction gaming applications at user device 130 with minimal (or no) frame loss, while also regulating power output to maximize available battery life.

In another example, the workload detector 110 can determine that a workload associated with a music streaming application is a background workload that is operable to output audio streams irrespective of a device state associated with a display/screen of user device 130. The system 100 can use the DVFS control value to control DVFS settings of one or more processor cores of the SoC 102 to minimize power consumption at the user device 130. In some implementations, the DVFS settings are controlled in a manner that allows users to play high interaction gaming applications at user device 130 with minimal (or no) frame loss.

FIG. 6 shows an example frequency prediction ML model 600. In some implementations, the frequency prediction ML model 600 is included in the example DVFS prediction models 113 described above with reference to FIG. 1. As discussed above, machine-learning architectures are used to perform a variety of tasks related to classification or pattern recognition, predictions that involve data modeling, and information clustering. In the example of FIG. 6, the frequency prediction ML model 600 employs one or more neural networks with multiple layers of nodes to generate an output, e.g., a classification, for a received input. The neural network(s) include one or more hidden layers in addition to an input layer and a corresponding output layer.

In some implementations, the neural network is a convolutional neural network (CNN) or a recurrent neural network (RNN). The neural network layers can have a corresponding set of parameters or weights. The weights are used to process inputs (e.g., a batch of inputs) through the neural network layers (e.g., the hidden layers) to generate a corresponding output of the layer for computing a neural network inference. In some implementations, the weights are updated during training using back propagation techniques. A batch of inputs and a set of kernels that are processed through the layers can be represented as respective tensors, such as a first multi-dimensional array of inputs and a second, different multi-dimensional array of weights.

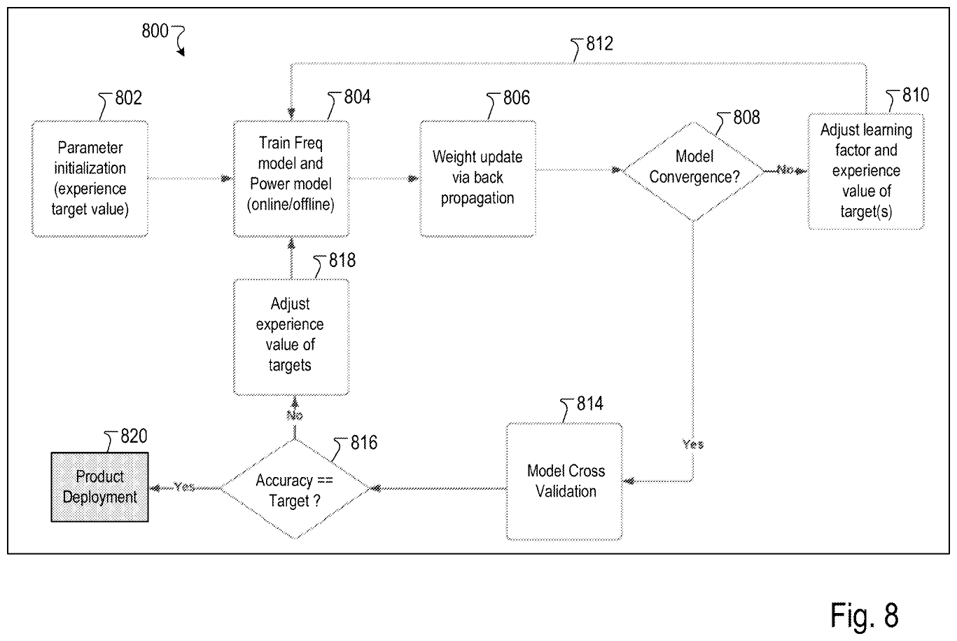

The frequency prediction ML model 600 is configured to generate an inference output from a received set of inputs 604 according to current values of a respective set of weights for the one or more neural network layers 602. In more detail, the frequency prediction ML model 600 processes the set of inputs 604 through the one or more neural network layers 602 to generate one or more frequency predictions 608 (described below). The frequency prediction ML model 600 processes the set of inputs 604 in accordance with an adaptive ML algorithm and corresponding cost function 620, which may be applied by the frequency prediction ML model 600. This is described in more detail below with reference to FIG. 8.

The set of inputs 604 can include one or more indicators 606 and a workload type indicator 118. The indicators 606 can include kernel level statistics that are useful for accurately generating ML frequency predictions that minimize cost functions associated with the frequency prediction ML model 600. For example, these indicators 606 can include: i) a number of draw calls from the CPU 104 to the IP block 108 representing a request to render graphical content or images; ii) a number of primitives and vertices for rendering shapes and/or features of objects in the content/images; iii) texture bandwidth and level of detail (LoD) for rendering the objects; iv) texture filter type (e.g., bilinear/trilinear/anisotropic) for the rendering quality for angles/surface of the objects; and v) resolution for object rendering (e.g., 720p, 1080p, 2k, 4k, etc.).

In some implementations, the indicators 606 include certain performance/hardware counters, or corresponding hardware signals, that provide more accurate granularity for computing inferences/predictions that allow for optimizing operating points across system 100. For example, hardware indicators 606 can be performance counter values and/or hardware signals that accurately indicate CPU utilization, memory utilization, and IP block utilization, such as TPU/GPU/ISP/DSP utilization. The indicators 606 can include corresponding hardware counters that indicate core processing activity for cores of the CPU 104 or GPU 120.

In some implementations, the indicators 606 can include performance/counter signals that represent cache hit/miss indicators that reveal an amount of cache misses. For example, the cache hit/miss indicators can be processed by the DVFS prediction models 113 to predict DVFS settings that provide a performance boost by mitigating or minimizing cache misses that degrade system performance. The indicators 606 also include certain performance counters for capturing load/store activity, such as a load/store ratio or a quantity of memory access requests issued for memory units across system 100, including memory device 128.

The generated frequency predictions 608 can include a CPU frequency prediction 610, an IP block frequency prediction 612, and a memory device frequency prediction 614. In some implementations, the indicators 606 are kernel level statistics that are specific to GPU 120, such that the IP block frequency 612 is a GPU frequency that is passed to the GPU 120. Likewise, indicators 606 and kernel level statistics specific to CPU 104 or memory device 128 can be used to generate frequency predictions 608 that include a CPU frequency setting that is passed to CPU 104 or a DDR/DRAM frequency setting that is passed to the memory device 128. In some implementations, the DDR/DRAM frequency value is passed to the memory device 128 via memory interface (MIF) managed by a memory controller of the SoC 102.

FIG. 7 shows an example power prediction ML model 700. In some implementations, in addition to the frequency prediction ML model 600, the power prediction ML model 700 is also included in the example DVFS prediction models 113 described above with reference to FIG. 1.

In the example of FIG. 7, the power prediction ML model 700 can have a structure that is similar to, e.g., substantially similar to, the frequency prediction ML model 600 of FIG. 6. For example, the power prediction ML model 700 employs one or more neural networks with multiple layers of nodes to generate an output, e.g., a classification, for a received input. In some implementations, the neural network(s) includes hidden layers in addition to an input layer and a corresponding output layer. The neural network can be a convolutional neural network (CNN) or a recurrent neural network (RNN).

Additionally, some (or all) neural network layers of the power prediction ML model 700 have a corresponding set of parameters or weights. The weights are used to process inputs (e.g., a batch of inputs) through the neural network layers (e.g., the hidden layers) to generate a corresponding output of the layer for computing a neural network inference. In some implementations, the weights are updated during a training phase of the power prediction ML model 700 using back propagation techniques. Like the frequency prediction ML model 600, a batch of inputs and a kernel filter of weights that are processed through the layers of the power prediction ML model 700 can be represented respectively as an input tensor and a weight/parameter tensor.

The power prediction ML model 700 is configured to generate an inference output from a received set of inputs 704 according to current values of a respective set of weights for the one or more neural network layers 702. In more detail, the power prediction ML model 700 processes the set of inputs 704 through the one or more neural network layers 702 to generate one or more power predictions 708 (described below). The power predictions 708 can represent power values for establishing DVFS settings across system 100. The power prediction ML model 700 processes the set of inputs 704 in accordance with an adaptive ML algorithm and corresponding cost function 720, which may be applied by the power prediction ML model 700. This is described in more detail below with reference to FIG. 8.

The set of inputs 704 can include one or more indicators 706 and a workload type indicator 118. The indicators 706 can include kernel level statistics that are useful for accurately generating ML power predictions that minimize cost functions corresponding to the power prediction ML model 700. For example, these indicators 706 can include hardware indicators such as: i) performance counters and corresponding count values generated by the performance counters (as described above at FIG. 6); ii) temperature sensors and corresponding temperature values generated by the temperature sensors; iii) current sensors and corresponding current values generated by the current sensors; and iv) droop detectors and corresponding droop values generated by the droop detectors.

In some implementations, the power prediction ML model 700 processes/analyzes indicators 706 representing temperature and/or current sensor values to compute, infer, or predict certain relationships and correlations. For example, the inferences or predictions can reveal the extent to which increases in power and/or frequency settings leads to corresponding temperature increases, including any associated correlations between current and temperature across the SoC 102 and system 100. In some implementations, the temperature sensors/indicators include internal/junction temp sensors and skin temperature sensors on a printed circuit board (PCB) that generate indications of external surface temperature of the user device. The power prediction ML model 700 processes these indicators to generate power predictions 708 and related DVFS settings that trigger thermal throttling and regulate power consumption at system 100. For example, the DVFS settings can dynamically set temperature thresholds or ranges (e.g., 85° F.-92° F.) for triggering thermal throttle functions of the system 100.

In some implementations, the droop detectors are voltage and/or time-based sensors that detect or measure transient droops in supply voltage. For example, the droops can occur as a result of transient current spikes due to switching circuitry of the SoC 102, where the spikes can cause local supply voltage droops due to resistive or inductive impedances in the on and off-chip power supply network. Significant or excessive voltage droop can degrade system performance and reliability.

The power prediction ML model 700 can process indicators 706 that include at least droop detector sensor values to generate power setting predictions 708 that achieve efficient power consumption levels at the SoC 102. In some cases, dynamic frequency scaling or reduction can be used for droop mitigation. Hence, the power prediction ML model 700 can process indicators 706 and determine a weighting for droop detector sensor values that allow for maximizing a predicted IP block frequency setting while also enabling effective droop mitigation. Additionally, the power prediction ML model 700 can generate power setting predictions 708 that minimize power consumption to achieve an efficient power output levels for a desired operating frequency that mitigates certain QoS violations.

The generated power level predictions 708 can include a CPU power setting 710, an IP block power setting 712, and a memory device power setting 714. In some implementations, the indicators 706 are kernel level statistics that are specific to memory device 128, such that the predicted MIF/DDR power setting 714 includes a DRAM power value that is passed to the memory device 128, e.g., using the memory controller or MIF of the SoC 102. Likewise, indicators 706 and kernel level statistics specific to CPU 104 or IP block 108 can be used to generate power level predictions 608 that include a CPU power setting that is passed to CPU 104 or an IP block 108 power setting(s) passed to one or more IP devices, such as GPU 120, TPU 122, DSP 124, or ISP 126.

FIG. 8 is an example flow diagram representing a process 800 for training at least the frequency and power prediction models 600, 700. In general, process 800 corresponds to model training phase that precedes a model deployment or implementation phase. During the deployment phase a trained model is used, for example, at runtime to generate predictions/inferences that are used to adjust DVFS settings at the SoC 102 or at an IP device coupled to the SoC 102. As indicated above, adjusting a DVFS setting at the SoC 102 can include adjusting DVFS settings at any hardware element (e.g., IP device) of the IP block 108. Adjusting a DVFS setting

Process 800 can be implemented or executed using system 100. Hence, descriptions of process 800 may reference the above-mentioned computing resources of system 100, including resources of the SoC 102. In some examples, the steps or actions of process 800 are enabled by programmed software instructions, firmware instructions, or both. Each type of instruction may be stored in a non-transitory machine-readable storage device and is executable by one or more of the processors or other resources described in this document, such as the CPU 104, the GPU, 120, the TPU 122, the DSP 124, or a combination of these.

Process 800 includes determining and initializing one or more parameters that represent experience target values (802). In some implementations, the experience target values are used to define or determine QoS violations. For example, the experience target values can be key performance indicators (KPIs) for a given workload or workload type. The experience target values can be user specified or dynamically determined at system 100. In some implementations, experience target values are threshold quality control values for enforcing certain QoS requirements, such as ensuring an image post-processing operation is computed as fast as possible (e.g., minimal latency) or that a gaming application iterates through multiple scene changes without dropping a single frame or without exceeding the target lost frame value.

The system 100 trains each of the frequency prediction ML model 600 and the power prediction ML model 700 (804). In some implementations, the frequency prediction ML model 600 is trained online for a threshold period of time. For example, a training phase of the frequency prediction ML model 600 can occur over hours, days, weeks, or months. In some cases, the frequency prediction ML model 600 can be also trained offline. The online aspect of the training phase means that the frequency prediction ML model 600 is trained on-device using violation data obtained from an example violation counter of the device. For example, the violation counter may only be active when a user executes and/or interacts with an application, which corresponds to the online aspects of the training phase. The device can be a user device described above with reference to FIG. 1.

The system 100 can perform various weight update operations via back propagation (806). The weight updates can involve embedding layer operations to generate sets of embeddings for training a neural network. An embedding layer of a neural network is used to embed features in a feature/embedding space corresponding to the embedding layer. An embedding vector can be a respective vector of numbers that is mapped to a corresponding feature in a set of features of a lookup table that represents an embedding layer. A feature can be an attribute or property that is shared by independent units on which analysis or prediction is to be performed.

For example, the independent units can be groups of words in a vocabulary or image pixels that form parts of items such as images and other documents. An algorithm for training embeddings of an embedding layer can be executed by a neural network processor to map features to embedding vectors. In some implementations, embeddings of an embedding table are learned jointly with other layers of the neural network for which the embeddings are to be used. This type of learning occurs by back propagating gradients to update the embedding tables.

Embedding outputs are generated when a neural network of system 100 is trained to perform certain computational functions, such as computations related to machine translation, natural language understanding, ranking models, or content recommendation models. Training the neural network involves updating a set of embeddings that were previously stored in an embedding table of the neural network, such as during a prior phase of training the neural network. The embeddings may be trained jointly with the neural network for which the embeddings are to be used.

The system 100 determines a particular model has reached convergence (808). The system 100 determines whether the frequency prediction ML model 600 has reached convergence during a training phase of that model. For example, the system 100 determines model convergence of the frequency prediction ML model 600 based on a corresponding cost function 406 for that model 600. Likewise, the system 100 determines whether the power prediction ML model 700 has reached convergence during a training phase of that model. For example, the system 100 also determines model convergence of the power prediction ML model 700 based on a corresponding cost function 406 for that model 700.

The DVFS prediction engine 106 can determine the extent to which a particular model reaches convergence based on a parameter value for a QoS cost function 406 that quantifies an error between predicted and expected values. For a given QoS cost function 406, the DVFS prediction engine 106 can generate a model convergence parameter value that characterizes the extent to which a model's predicted values match, or are consistent with, expected values for inference outputs generated by the model. In some implementations, the model convergence parameter value is compared to a convergence threshold value that represents a desired consistency between the predicted and expected values. For example, the DVFS prediction engine 106 can determine model convergence in response to determining that a model convergence parameter value (e.g., 0.91) meets or exceeds a corresponding threshold value (e.g., 0.90).

As described above, the adaptive learning module 112 can include multiple QoS cost functions 406, where each QoS cost function 406 may correspond to one or more ML models 402. For example, the adaptive learning module 112 is configured to access each of frequency, power prediction ML models 600, 700 and corresponding adaptive QoS cost functions 406 for each model 600, 700 and/or workload type that is detectable by the workload detector 110. The DVFS prediction engine 106 leverages this attribute of the adaptive learning module 112 to dynamically determine control values, including thresholds, for each QoS parameter based on the one or more ML models 600, 700, workload types 118, and corresponding QoS cost functions 406.

In response to determining that a particular model has not reached convergence, the system 100 adjusts learning factors and experience values of one or more targets (810). For example, the DVFS prediction engine 106 adjusts a learning factor and an experience value of a target based on a feedback path 812. The feedback path 812 can represent, or route, a feedback control signal 812, such as a signal that is generated based on a model convergence parameter value (e.g., 0.75) that does not meet or exceed a corresponding threshold value (e.g., 0.90). In some implementations, the experience target values include target values described above at least with reference to the examples of FIG. 3 and FIG. 4.

In response to determining that a model has reached convergence, the system 100 performs cross validation of that model (814). The DVFS prediction engine 106 uses example cross validation techniques to evaluate performance of a model on new, unseen data. In some implementations, the system 100 parses or divides its available training data into various subsets that include training datasets used to train the model and a corresponding validation dataset used to evaluate performance of the model after the training iteration. Each of these respective datasets can be described or identified as “folds,” where a given validation dataset can represent a type of new, unseen data to the model.

The DVFS prediction engine 106 can repeat the model training and validation process for different training iterations of a particular ML model of system 100, designating different folds or combinations of datasets as either the training or validation datasets. In some implementations, the system 100 repeats or iterates this model training and validation process N times, where N is an integer greater than or equal to 1. To evaluate model performance at each training iteration, the DVFS prediction engine 106 reserves or designates a different fold as the validation dataset, where that particular fold is excluded from the designated training datasets.

In some implementations, the DVFS prediction engine 106 includes training datasets and a corresponding validation dataset for each of ML models 402. For example, the DVFS prediction engine 106 can include or obtain these datasets for a power ML model, a frequency ML model, or both. In some examples, the DVFS prediction engine 106 can also include or obtain these datasets for an ML model associated with the workload detector 110.

The DVFS prediction engine 106 can generate a model performance metric for each training evaluation or iteration of a model. The DVFS prediction engine 106 can also generate a composite performance metric for a given model by combining or averaging the respective performance metric for each training evaluation or iteration of that model. The system 100 performs cross validation such that ML models selected for deployment demonstrate robust performance that generalizes well to new, unseen data. In some implementations, the DVFS prediction engine 106 uses cross validation to mitigate or prevent overfitting of a particular model, which can occur when a model's training is tied exclusively to observations derived from its training dataset, such that it performs poorly on new, unseen data.

Following cross validation of the model, the system 100 determines whether an observed accuracy of a model meets or exceeds a target accuracy (816). Each of the observed accuracy and the target accuracy may be characterized by a numerical value, such as an integer (e.g., 7) value or a decimal value (e.g., 0.87). The DVFS prediction engine 106 can assess model accuracy by comparing values of inference outputs generated by a model to a corresponding target value for that output. The DVFS prediction engine 106 performs this model accuracy for each of the frequency prediction ML model 600 as well as the power prediction ML model 700. Thus, examples and references to the frequency prediction ML model 600 in the following examples can also be applied to power prediction ML model 700.

For example, during model training and for a detected workload type 118 that is a low-interaction gaming workload 228, the frequency prediction ML model 600 generates an IP block frequency prediction 612 for GPU 120. For example, the frequency prediction 612 can be a predicted minimum GPU frequency value (e.g., 1.5 GigaHertz (GHz)) that is predicted to mitigate or preclude occurrence of a QoS violation relating to lost frames and/or a slow FPS value such as an FPS value that is below a particular threshold value (e.g., a 60 FPS threshold). During model training the frequency or power predictions 608, 708 are aspirational, such that an IP block frequency or power setting prediction 612, 712 is intended to satisfy constraints imposed by a corresponding QoS cost function 620, 720, respectively.

During training, the DVFS prediction engine 106 can determine that the observed accuracy of frequency prediction ML model 600 does not meet or exceed a target accuracy for the model. For example, the DVFS prediction engine 106 can make this determination if, when called or used to render graphical content for the low-interaction gaming workload 228, a QoS violation for lost frames and/or a slow FPS occurs after the GPU 120 begins to operate at the predicted minimum GPU frequency value. If system 100 determines that the observed accuracy of frequency prediction ML model 600 does not meet or exceed a target accuracy, then the system 100 can again adjust one or more experience target values associated with the model (818) and extend that model's training phase by iterating process 800 to resume training the model at process step 804. The system 100 can make similar determinations, adjustments, and training phase extensions for the power prediction ML model 700.

The DVFS prediction engine 106 can also assess model accuracy relative to a target accuracy in other ways. For example, the DVFS prediction engine 106 can encode target accuracy or frequency (or power consumption) values for accessing accuracy of the frequency (or power) prediction ML model 600 (or 700). The encoded values can be derived from annotated training samples that indicate acceptable ranges of minimum frequency prediction values 608 for specific workload types 110 and different combinations of input indicators 606. The DVFS prediction engine 106 can compare different frequency predictions 608 to one or more of its encoded target frequency values. The DVFS prediction engine 106 determines whether an observed accuracy of the frequency prediction ML model 600 meets or exceeds a target accuracy based on results of that comparison.

The system 100 concludes one or more training phases of the frequency prediction ML model 600 in response to determining that an observed accuracy of the frequency prediction ML model 600 meets or exceeds a target accuracy for the model. Relatedly, the system 100 concludes one or more training phases of the power prediction ML model 700 in response to determining that an observed accuracy of the power prediction ML model 700 meets or exceeds a target accuracy for the model. For example, the TPU 122 can be requested to perform intensive inference computations for a compute heavy ML workload 210 within a target latency for such workload types. The frequency/power prediction ML model 600/700 can generate a frequency/power prediction 612/712 that includes a predicted minimum TPU frequency/power setting value for executing the compute heavy ML workload 210 within the target latency.

The DVFS prediction engine 106 determines that the frequency prediction ML model 600 meets or exceeds the target accuracy based on the predicted minimum TPU frequency value and/or corresponding minimum power setting value. For example, the DVFS prediction engine 106 passes the frequency prediction 612 to the TPU 122 to cause the TPU 122 to set its operating frequency to the minimum TPU frequency indicated by the frequency prediction 612. The TPU 122 uses this minimum TPU operating frequency to perform the intensive inference computations for the compute heavy ML workload 210. The DVFS prediction engine 106 determines whether the TPU 122 executed the compute heavy ML workload 210 within the target latency while the TPU 122 was operating at the predicted minimum operating frequency.

Alternatively, the DVFS prediction engine 106 determines if a QoS violation for exceeding the latency target occurred after the TPU 122 executes the compute heavy ML workload 210 while operating at the predicted minimum TPU operating frequency. In some implementations, the system 100 generates a corresponding QoS check in response to performing a particular workload type using a predicted DVFS setting, such as a predicted frequency or power value. The DVFS prediction engine 106 determines that the frequency prediction ML model 600 meets or exceeds the target accuracy if, while operating at the predicted minimum TPU operating frequency: i) the TPU 122 executes the compute heavy ML workload 210 within the target latency or ii) no QoS violation for exceeding the latency target occurs after the TPU 122 executes the compute heavy ML workload 210.

Relating to the above example(s), the DVFS prediction engine 106 can determine that the observed accuracy of the frequency prediction ML model 600 meets or exceeds a target accuracy based on a lack of QoS violations for a given frequency prediction 608 and corresponding workload type 118. In some implementations, a specific frequency prediction(s) 608 is generated for a specific workload type(s) 118 and the DVFS prediction engine 106 can determine that no QoS violations occurred when a frequency value(s) of the specific prediction(s) 608 is used to a regulate operating frequency at a device(s) of system 100 used to execute that specific workload type 118.

If system 100 determines that the observed accuracy of frequency prediction ML model 600 meets or exceeds the target accuracy, then the system 100 deploys the DVFS prediction models 113 for use during an implementation phase of the models (820). Corresponding examples related to power prediction ML model 700 and related power predictions 708 pertain equally to process 800.

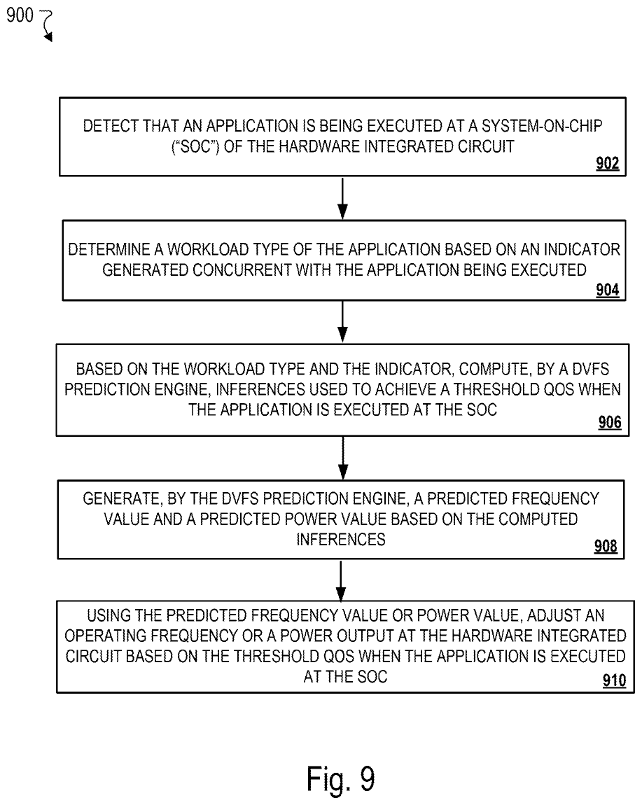

FIG. 9 is an example process 900 for frequency and power predictions at a hardware integrated circuit. Process 900 can be implemented or executed using system 100 and the SoC 102, including the predictive models described above. Hence, descriptions of process 900 may reference the above-mentioned computing resources of system 100 and SoC 102. In some examples, the steps or actions of process 900 are enabled by programmed software instructions, firmware instructions, or both. Each type of instruction may be stored in a non-transitory machine-readable storage device and is executable by one or more of the processors or other resources described in this document, such as the CPU 104, a scalar core or compute tile of the TPU 122, a hardware ML accelerator, or a neural network processor.

In some implementations, the steps of process 900 are performed at an integrated hardware circuit to generate a machine-learning (ML) output, including an output for a neural network layer of a multi-layer neural network that implements one or more ML models. For example, the output can be a portion of a computation for a ML task or inference workload to generate an image processing, speech processing, or image recognition output. As indicated above, the integrated hardware circuit can be a special-purpose neural network processor or hardware ML accelerator configured to accelerate ML computations for generating different types of data processing outputs.

Referring again to process 900, system 100 detects that an application is being executed at an SoC (902). The DVFS prediction engine 106 can detect that application is being executed based on data or indicator values from the CPU 104. For example, the CPU 104 generates one or more indicators 105, such as an app-launch indicator or a function call that is triggered in response to executing or launching an application at a user device.

The system 100 determines a workload type of the application based on one or more indicators 105 that are generated concurrent with the application being executed (904). A DVFS prediction engine 106 of SoC 102 computes one or more inferences based on the workload type and the indicator (906). The computed inferences are used to achieve a threshold quality of service (“QoS”) when the application, such as for gaming, content streaming, or video editing, is executed at the SoC 102.

The DVFS prediction engine 106 generates a predicted frequency value and a predicted power value from the computed inferences (908). In some implementations, the DVFS prediction engine 106 uses the frequency prediction ML model 600 to predict a minimum GPU frequency value (e.g., 1.5 GigaHertz (GHz)) for a clock signal of the GPU 120 that minimizes QoS violations relating to lost frames, FPS, or UI responsiveness for different workload types.

The predicted frequency value or power value is used to adjust an operating frequency or a power output at the hardware integrated circuit to achieve a threshold QoS when the application is executed at the SoC (910). For example, the DVFS prediction engine 106 uses the predicted values to adjust DVFS settings more efficiently to achieve the fastest frequency and lowest power consumption operating points. In some implementations, the frequency and power predictions 608, 708 provide example DVFS settings for thermal throttling that are dynamically adjusted for different workload types and/or external user device conditions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method for frequency and power predictions at a hardware integrated circuit, the method comprising:
detecting that an application is being executed at a system-on-chip (“SoC”) of the hardware integrated circuit;
determining a workload type of the application based on an indicator generated concurrent with the application being executed;
based on the workload type and the indicator, computing, by a Dynamic Variable Frequency Signal (“DVFS”) prediction engine of the SoC, inferences used to achieve a threshold quality of service (“QoS”) when the application is executed at the SoC;
generating, by the DVFS prediction engine, a predicted frequency value and a predicted power value from the computed inferences; and
adjusting, using the predicted frequency value or power value, an operating frequency or a power output at the hardware integrated circuit to achieve a threshold QoS when the application is executed at the SoC.

2. The method of claim 1, wherein generating a predicted frequency value and a predicted power value from the computed inferences comprises:
generating, by the DVFS prediction engine, a minimum frequency value and a corresponding minimum power value to achieve the threshold QoS when the application is executed at the SoC.

3. The method of claim 1, wherein generating a predicted frequency value and a predicted power value from the computed inferences comprises:
generating, by the DVFS prediction engine, a maximum frequency value and a corresponding minimum power value required to implement a maximum operating frequency at the hardware integrated circuit based on the maximum frequency value.

4. The method of claim 1, wherein computing the inferences comprises:
computing inferences by a frequency prediction model of the DVFS prediction engine based on the workload type and the indicator; and
computing inferences by a power prediction model of the DVFS prediction engine based on the workload type and the indicator.

5. The method of claim 4, wherein:
the SoC is integrated in a user device; and
the frequency prediction model is trained and executed on the SoC.

6. The method of claim 4, wherein:
the power prediction model is a pre-trained neural network model;
the power prediction model is trained offline, separate from the SoC and the user device, and then loaded onto the SoC for execution at the user device.

7. The method of claim 1, wherein the SoC is for a user device and the method further comprises:
determining a first workload type of a first application executed at the user device;
adjusting the operating frequency and the power output at the hardware integrated circuit using predicted frequency and power values generated from inferences computed by the DVFS prediction engine based on the first workload type;
determining a second workload type of a second application executed at the user device; and
adjusting the operating frequency and the power output at the hardware integrated circuit using predicted frequency and power values generated from inferences computed by the DVFS prediction engine based on the second workload type.

8. The method of claim 7, further comprising:
adjusting the operating frequency or the power output with reference to the first workload type to achieve a first threshold QoS when the first application is executed at the SoC; and
adjusting the operating frequency or the power output with reference to the second workload type to achieve a second threshold QoS when the second application is executed at the SoC.

9. The method of claim 8, wherein:
the first workload type and the second workload type are different workload types; and
the first application and the second application are the same application.

10. The method of claim 1, wherein computing the inferences comprises:
computing the inferences based on the workload type, a plurality of software indicators, and a plurality of hardware indicators.

11. A System-on-Chip (“SoC”) that implements frequency and power predictions for a hardware integrated circuit, the system-on-chip comprising:
a processing device; and
a non-transitory machine-readable storage device for storing instructions that are executable by the processing device to cause performance of operations comprising:
detecting that an application is being executed at the hardware integrated circuit;
determining a workload type of the application based on an indicator generated concurrent with the application being executed;
based on the workload type and the indicator, computing, by a Dynamic Variable Frequency Signal (“DVFS”) prediction engine of the SoC, inferences used to achieve a threshold quality of service (“QoS”) when the application is executed at the SoC;
generating, by the DVFS prediction engine, a predicted frequency value and a predicted power value from the computed inferences; and
adjusting, using the predicted frequency value or power value, an operating frequency or a power output at the hardware integrated circuit to achieve a threshold QoS when the application is executed at the SoC.

12. The SoC of claim 11, wherein generating a predicted frequency value and a predicted power value from the computed inferences comprises:
generating, by the DVFS prediction engine, a minimum frequency value and a corresponding minimum power value to achieve the threshold QoS when the application is executed at the SoC.

13. The SoC of claim 11, wherein generating a predicted frequency value and a predicted power value from the computed inferences comprises:
generating, by the DVFS prediction engine, a maximum frequency value and a corresponding minimum power value required to implement a maximum operating frequency at the hardware integrated circuit based on the maximum frequency value.

14. The SoC of claim 11, wherein computing the inferences comprises:
computing inferences by a frequency prediction model of the DVFS prediction engine based on the workload type and the indicator; and
computing inferences by a power prediction model of the DVFS prediction engine based on the workload type and the indicator.

15. The SoC of claim 14, wherein:
the SoC is integrated in a user device; and
the frequency prediction model is trained and executed at the user device.

16. The SoC of claim 15, wherein:
the power prediction model is a pre-trained neural network model;
the power prediction model is trained offline, separate from the SoC and the user device, and then loaded onto the SoC for execution at the user device.

17. The SoC of claim 11, wherein the SoC is for a user device and the operations comprising:
determining a first workload type of a first application executed at the user device;
adjusting the operating frequency and the power output at the hardware integrated circuit using predicted frequency and power values generated from inferences computed by the DVFS prediction engine based on the first workload type;
determining a second workload type of a second application executed at the user device; and
adjusting the operating frequency and the power output at the hardware integrated circuit using predicted frequency and power values generated from inferences computed by the DVFS prediction engine based on the second workload type.

18. The SoC of claim 17, wherein the operations further comprise:
adjusting the operating frequency or the power output with reference to the first workload type to achieve a first threshold QoS when the first application is executed at the SoC; and
adjusting the operating frequency or the power output with reference to the second workload type to achieve a second threshold QoS when the second application is executed at the SoC.

19. The SoC of claim 18, wherein:
the first workload type and the second workload type are different workload types; and
the first application and the second application are the same application.

20. The SoC of claim 11, wherein computing the inferences comprises:
computing the inferences based on the workload type, a plurality of software indicators, and a plurality of hardware indicators.
